(19) United States
(12) Patent Application Publication
(10) Pub. No.: US 2013/0041737 A1
(43) Pub. Date: Feb. 14, 2013

(54) ELECTRONIC COUPON SYSTEM AND METHOD

(71) Applicants: Rajeev Mishra, Lebanon, NH (US); Dheeraj Mishra, Hanover, NH (US)

(72) Inventors: Rajeev Mishra, Lebanon, NH (US); Dheeraj Mishra, Hanover, NH (US)

(21) Appl. No.: 13/208,058

(22) Filed: Aug. 11, 2011

(51) Int. Cl. G06Q 30/00

(52) U.S. Cl. 705/14.26; 705/14.39

(57) ABSTRACT

A coupon creation, publication, and redemption system and method includes a business account module at a server configured to assign a deal creation power to a product or service provider accessing a website with a client, and a coupon generation module configured to generate a listing of a deal and a predetermined number of coupons associated with a deal. The coupon is published via the website. The provider's history of coupon generation is tracked. Coupon grabbing and redemption powers are assigned to a consumer. The consumer grabs the coupons via the website, and its history of coupon grabbing is tracked. When a sale consummated, the grabbed coupon is marked as redeemed, while both the consumer's and the provider's history of coupon redemption is updated. The consumer's grabbing power is transformed in accordance with at least one of the consumer's coupon grabbing and coupon redemption history. The deal provider's deal creation power is transformed in accordance with at least one of the provider's coupon generation and coupon redemption history.

### BACKGROUND

1. Technical Field

This invention relates to web-enabled transactions, and more particularly to an automated system for coupon publishing, advertising and redemption.

2. Background Information

Retailing is the exchange—sale and purchase—of goods and services between a vendor or merchant, and a consumer or customer. Typically, negotiation is absent between the vendor and consumer with respect to the terms of a sale or purchase of a good or service. Retailing characteristically employs a vendor-controlled format whereby the vendor determines which goods or services to offer for sale, when the goods or services will be offered for sale, and the non-negotiable fixed price at which the good or service will be sold.

Discounts are an integral part of retail strategies for many goods and services. Vendors rely upon discounts for a variety of reasons, such as to promote new and existing goods and services and to increase the sales of that particular item or service, or to increase the sales of the merchant's other goods and services. Further, consumers rely upon discounts as a way to reduce their costs.

Discount techniques include providing coupons and rebates to potential customers, but conventional techniques have several disadvantages, such as an historically small percentage of consumer participation and fraud. Since the participation level is so small, merchants are forced to canvass an area to attract the correct demographic of potential customers for its products or services. Most of the coupons or rebates (or the advertisements containing the coupons or rebates) end up with consumers that do not need or want the goods or services.

Further, fraud is an increasing problem in that coupons may be copied, or rebates may be used to obtain cash back for goods and services that the fraudulent consumer never actually purchased.

Coupons and rebates are typically distributed using direct mail, newspaper print, and magazines, and a low percentage of the distributed coupons actually result in a sale. Besides not being environmentally friendly due to paper waste, coupons and rebates may not be cost effective due to their relatively low level of resulting sales.

Further, advertising and marketing associated with coupons and rebates can be expensive when done through radio or television medium, and relatively ineffective when done through print advertisements.

A vendor offers coupons or rebates in the hopes of securing future sales at full retail prices, repeat sales, and ultimately an increase in overall sales. Ultimately, vendors cannot offer goods and services at a discount unless the vendor can ensure a minimum number of sales to justify the discount.

Systems such as websites offering “daily deals” attempt to address some of the foregoing concerns, by facilitating online advertising and encouraging large numbers of participants to agree to a purchase before anyone is able to consummate a purchase. These systems, however, is not without drawbacks. For example, they tend to be relatively expensive, often charging up to 50% of the amount paid by each coupon redeemer, e.g., up to 50% of the already discounted deal price. Payments are also typically made directly to the website operator, and are not passed on to the businesses until well after coupon redemption, which tends to hurt cash flow for the businesses. Still further, the business generally has only limited ways of controlling the number of responses to their offer(s), which may result to either too great or too little response. This problem of planning for the number of responses is also an issue for the conventional approach of simply publishing a coupon as discussed above, and exists even in the event the business limits the number of coupons mailed or downloaded, the small fraction of published coupons that ultimately get redeemed tends to be unpredictable.

Moreover, these traditional coupon systems generally are not conducive to releasing coupons frequently, such as for different products/services.

Therefore, a need exists for a coupon creation, publishing, and redemption system that addresses the foregoing drawbacks.

### SUMMARY

In one aspect of the present invention, a computer implemented system in a client-server environment is provided for coupon creation, publication, and redemption. The system includes a server having a business account module configured to assign a deal creation power to a product or service provider accessing a website with a client, and a coupon generation module configured to generate, on behalf of the provider, a listing of a deal and a predetermined number of coupons associated with a deal. The coupon generation module is configured to publish the coupons via the website. A database is configured for recording and updating the provider's history of coupon generation, and a member account module is configured to assign a coupon grabbing power and a coupon redemption power to a product or service consumer. A coupon grabbing module enables the consumer to grab at least one of the coupons via a client accessing the website. The database is configured for recording and updating the consumer's history of coupon grabbing. A redemption module enables the grabbed coupon to be redeemed, with the database recording and updating the consumer's and the provider's history of coupon redemption. The redemption module transforms the consumer's grabbing power in accordance with at least one of the consumer's history of coupon grabbing and history of coupon redemption. The redemption module also transforms the provider's deal creation power in accordance with at least one of the provider's history of coupon generation and history of coupon redemption.

Another aspect of the present invention includes a computer implemented method in a client-server environment, for coupon creation, publication, and redemption. The method includes assigning a deal creation power to a product or service provider accessing a website with a client, and generating a listing of a deal and a predetermined number of coupons associated with a deal. Coupons are then published via the website. The provider's history of coupon generation is tracked and updated to a database. The method also includes assigning a coupon grabbing power and a coupon redemption power to a product or service consumer, and enabling the consumer to grab at least one of the coupons via a client accessing the website. The consumer's history of coupon grabbing is tracked and updated to the database. The grabbed coupon may be redeemed, and the consumer's and provider's coupon redemption history is tracked and updated to the database. The consumer's grabbing power is transformed in accordance with at least one of the consumer's history of coupon grabbing and history of coupon redemption, and the provider's deal creation power is transformed in accordance with at least one of the provider's history of coupon generation and history of coupon redemption.

In yet another aspect of the invention, an article of manufacture for coupon creation, publication, and redemption, in a client-server environment is provided. The article of manufacture includes a computer usable medium having a computer readable program code embodied therein, the computer usable medium has computer readable program code for implementing the computer implemented method described in the preceding paragraph.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of one embodiment of a network-based transaction facility;

FIG. 2 is a block diagram of one embodiment of a database maintained by a database engine server;

FIG. 3 is a diagrammatic representation of one embodiment of a user table within the database;

FIG. 4 is a diagrammatic representation of one embodiment of a user information table within the database;

FIG. 5 is a block diagram of one embodiment of the present invention in an exemplary client-server environment;

FIG. 6 is a block diagram of a collection of objects that generate the various interfaces shown in FIGS. 7-12;

FIGS. 7-12 are exemplary representations of various interfaces included in the sequence of interfaces shown in FIG. 6;

FIGS. 13-17D are flow charts of embodiments of methods in accordance with the present invention; and

FIG. 18 is a block diagram of one embodiment of a computer system usable with embodiments of the present invention.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. In addition, well-known structures, circuits and techniques have not been shown in detail in order not to obscure the understanding of this description. The following detailed description is, therefore, not to be taken in a limiting sense, and the scope of the present invention is defined by the appended claims and their equivalents.

### General Overview

Methods and apparatuses for providing automated coupon creation and redemption in a network-based transaction facility are described. In the following description, for purposes of explanation, numerous specific details are set forth in order to provide a thorough understanding of the present invention. It will be evident, however, to one skilled in the art that the present invention may be practiced without these specific details.

Embodiments of the present invention are intended to give the provider of a product or service (referred to herein as a business or provider) with substantially complete control of many aspects associated with publishing and managing various sales promotions (referred to herein variously as deals or coupons). Particular embodiments take the form of a self-service (e.g., self-provisioning) website or web-based service in which individual providers may login and define various parameters of an online promotion. Such parameters may include the number of products or services to be sold under promotion, e.g., in the form of coupons to be released/published, an amount or percentage to be discounted from a standard price for the product/service, start and end dates/times of the promotion, and the particular configuration, including text/pictures, of the coupon, etc.

These embodiments address the aforementioned drawbacks of the prior art by both enabling businesses to limit the number of coupons made available to the public, and providing an incentive for consumers (also referred to herein as a consumer or member) to only download a coupon if they intend to follow through with redemption, and to then follow through with the redemption. In this manner, these embodiments are configured to efficiently provide a relatively high, and predictable, level of sales results for any given promotion. This predictability and efficiency also tends to enable the businesses to better plan in advance for the expected sales. Moreover, this efficiency and predictability may also permit providers to offer a relatively large variety of promotions for a number of different product/service offerings.

These embodiments thus involve providing a workflow between businesses and consumers. The businesses (providers) are able to conveniently create and publish deals (e.g., coupons) on a webportal. The consumers (buyers) may then commit to use or redeem the coupon, in accordance with their effective purchasing (also referred to herein as “commit” or “coupon grabbing”) power as defined by the webportal. Once the buyer follows through and redeems the coupon, then the buyer's commit power is automatically increased, to enable them to commit to another deal.

As mentioned, in particular configurations the website will be running in a self-serve (self-provisioning) mode. To facilitate this, these embodiments provide for automatic verification of providers' “Business Accounts” (BA) and consumers' “Member Accounts” (MA), to help ensure that users do not post inappropriate content or take otherwise undesired actions via the website. Such verification may be accomplished using a variety of approaches, such as by automatically tracking the number of links (e.g., sales) between a BA user and MA users. For example, if a BA wishes to proceed from a lower to a higher level membership/account (e.g., for increased privileges), then this BA should be linked with a higher number of MAs (and correspondingly, these MAs would be linked with a number of BAs). The number of links, e.g., based on actual legitimate transactions via the website, would be expected to increase in relatively broad-based fashion for legitimate users, and would thus tend to be more trusted, and concomitantly, more worthy of increased privileges. Such an approach, which links between a variety of BA and MA users, helps prevent users from gaming the system by creating a large number of fictitious transactions among themselves in order to gain increased privileges. In addition, in particular embodiments, a site administrator may upgrade a business account to higher-level of privileges by manually editing the account.

Particular examples of these types of accounts, as used in embodiments of the present invention, will now be described in greater detail. As mentioned above, the website will provide for at least two types of users: Business Accounts (BA) and Buyers (Member) Accounts (MA). Each of these account types may have at least two sub-types, e.g., Unconfirmed and Confirmed, for a total of at least four account types in the example:

1. Unconfirmed Business Accounts;

2. Confirmed Business Accounts;

3. Unconfirmed Consumer/Member Accounts; and

4. Confirmed Consumer/Member Accounts.

In particular embodiments, discussed hereinbelow, a third sub-type, i.e., Preferred, may be provided for increased privileges beyond those associated with confirmed accounts.

Exemplary details of each type of account and how workflow will flow are as follows.

1. Unconfirmed Business Accounts

Signing up for business account may be a subscription based service which means that each new business account may be self-provisioned using a credit card. The instant inventors recognized, however, that credit card information is often stolen and therefore it may be useful to include safeguards to prevent fraudulent businesses from using an unauthorized credit card to create fraudulent deals. In order to help prevent such fraudulent behavior, each new BA account may be designated as “Unconfirmed”.

Unconfirmed Business Accounts may be provided with only limited authority to create deals/coupons, such as by limiting the number of deals and coupons they are permitted to create. These Unconfirmed BA users may also be prohibited from marking a coupon as redeemed without first obtaining a redemption code from the buyer of the particular coupon.

2. Confirmed Business Accounts

Once an Unconfirmed Business Account increases its Coupon Redemption History Rating (defined below) by a predetermined number, and/or achieves other milestones, it may automatically become a “Confirmed Business Account”. Confirmed Business Accounts may be provided with greater power to create or generate deals and release coupons. Confirmed BAs may not need a code from buyer to mark a coupon as redeemed via the website. It is noted that in particular embodiments, Confirmed BAs will not be able to modify their business name/address. If a change is required, then they will need to contact the website administrator with proof of change, so the administrator can make the change for them.

3. Unconfirmed Buyers Accounts

When a buyer (consumer) initially logs onto the website and/or otherwise opens an account, their default status may be “Unconfirmed”. This status will limit them so they have relatively little committing power. Once they successfully redeem a coupon, and/or achieve other milestones, their status may change to “Confirmed”.

4. Confirmed Buyers Accounts

This type of account may provides greater ability than Unconfirmed accounts to grow the user's committing power (but may still be capped at a predetermined level) to permit more shopping. The website/system may automatically track the user's redeem history which may be used to calculate the user's Coupon Commit Power.

Optionally, additional account types, such as “preferred” accounts, may be provided to users reaching additional milestones, to grant yet additional privileges, such as higher levels of creating and committing powers, and/or the ability to post Featured listings.

Terminology

For the purposes of the present specification, the term “transaction” shall be taken to include any communications between two or more entities and shall be construed to include, but not be limited to, commercial transactions including sale and purchase transactions, auctions and the like. The terms “computer”, “end-user device” and “client” are meant to encompass a workstation, personal computer, personal digital assistant (PDA), wireless telephone, or any other suitable computing device including a processor, a computer readable medium upon which computer readable program code (including instructions and/or data) may be disposed, and a user interface. Terms such as “server”, “application”, “engine” and the like are intended to refer to a computer-related component, including hardware, software, and/or software in execution. For example, an engine may be, but is not limited to being, a process running on a processor, a processor including an object, an executable, a thread of execution, a program, and a computer. Moreover, the various components may be localized on one computer and/or distributed between two or more computers. The terms “real-time” and “on-demand” refer to sensing and responding to external events nearly simultaneously (e.g., within milliseconds or microseconds) with their occurrence, or without intentional delay, given the processing limitations of the system and the time required to accurately respond to the inputs.

Terms such as “component” and “module”, and the like are intended to refer to a computer-related entity, either hardware, a combination of hardware and software, software, or software in execution. For example, a module may be, but is not limited to being, a process running on a processor, a processor, an object, an executable, a thread of execution, a program, and a computer. One or more modules may reside within a process and/or thread of execution and a module may be localized on one computer and/or distributed between two or more computers.

Additional terms are explained as follows.

Buyers Coupon Committing Power: Each buyer may be given a default coupon committing power when they initially sign up to the website. Depending upon further events their coupon committing power may increase/decrease. Below are some items which may be used to determine the coupon committing power of a buyer at a given point of time.

Referrals. Buyers may be provided with an option to invite their friends to join the website. If the friend ultimately signs in to the website and opens an account, then the referring party may be rewarded by an increase in coupon committing power.

Commits. A buyer's Committing Power may be reduced (e.g., by one) each time the buyer commits to redeem a coupon.

Redemptions. Once a buyer follow through with an actual redemption, his/her Committing Power may increase (e.g., by one).

Cap/Limit. There may be an upper limit to the number to the Coupon Committing Power a buyer may have at a given point in time.

Number of Coupons Redeemed: The system may keep track of how many coupons were redeemed by a buyer so far.

The following is an example of how the work flow may work with various embodiments described herein.

1. Business accesses the website and self-provisions a deal/coupon (e.g., 50% off an Automobile Inspection) for publication on the website.

2. Each deal will have a predetermined number of valid coupons.

3. Buyer commits, via the website, to one of the published coupons, using the buyer's current Coupon Commit Power.

4. Buyer's coupon commit power is reduced by 1.

5. Upon committing to a coupon, the website customizes or otherwise personalizes the coupon and electronically sends the personalized coupon to the buyer, e.g., in the form of an electronic file, token, app, etc., sent via email, through a social networking site such as Facebook or Twitter, and/or posted to the buyer's account on the website.

6. Buyer downloads and brings the customized coupon to the business. (Note that the customized coupon may be presented in substantially any form, such as a barcode, QR code, etc., displayable on a smart phone, iPad, or other personal electronic device, and/or which may be printed.)

7. Business serves the buyer and:
a. Marks the coupon as redeemed via the website; or
b. Gives buyer a code which the buyer may enter on the website
to mark the coupon redeemed.

8. Once a coupon is redeemed then system:
a. Increases Business's Coupon Releasing History
Rating by 1;
b. Increases Buyer's Coupon Redeemed History Rating
by 1; and
c. Increases Buyer's Coupon Commit Power by 1 so he/she
can do more shopping.

### Programming Languages

Systems and methods embodying the present invention can be programmed in any suitable language and technology, such as, but not limited to: C++; Visual Basic; Java; php; mysql; location databases; VBScript; Jscript; BCMAscript; DHTM1; XML and CGI. Alternative versions may be developed using other programming languages including, Hypertext Markup Language (HTML), Active ServerPages (ASP) and Javascript. Any suitable database technology can be employed, such as, but not limited to, Microsoft SQL Server or IBM AS 400.

Referring now to the Figures, embodiments of the present invention will be more thoroughly described.

Transaction Facility

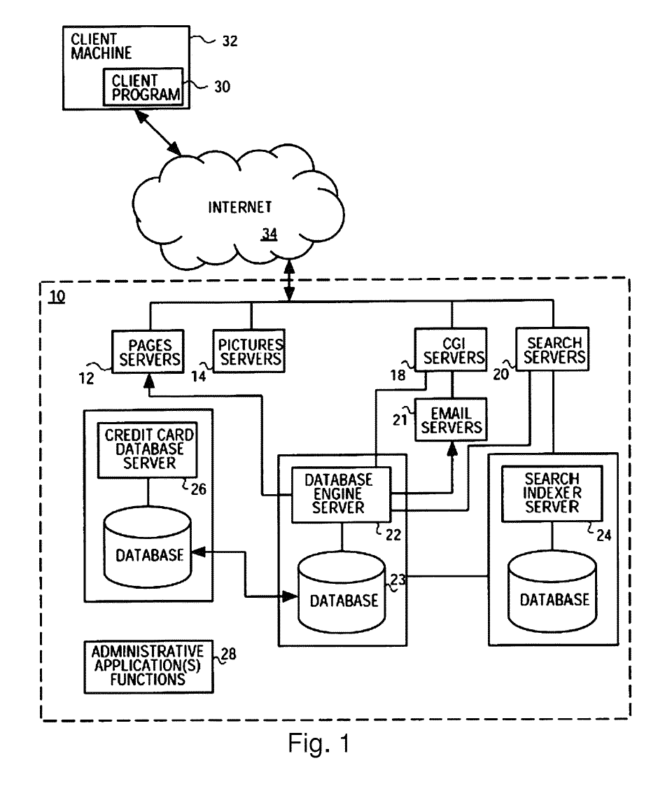

FIG. 1 is a block diagram illustrating an exemplary network-based transaction facility in the form of an Internet-based coupon generation and redemption facility 10. The coupon generation and redemption facility 10 includes one or more of a number of types of front-end servers, namely page servers 12 that deliver web pages (e.g., markup language coupons), picture servers 14 that dynamically deliver images to be displayed within Web pages, CGI (Common Gateway Interface) servers 18 that provide an intelligent interface to the back-end of facility 10, and search servers 20 that handle search requests to the facility 10. Communication (e.g., e-mail) servers 21 provide, inter alia, automated e-mail and/or social networking, etc., communications to users of the facility 10. The back-end servers may include a database engine server 22, a search index server 24 and a payment (e.g., credit card and/or subscription) database server 26, each of which may maintain and facilitate access to a respective database. Facility 10 may also include an administrative application server 28 configured to provide various administrative functions.

The network-based coupon generation and redemption facility 10 may be accessed by a client program 30, such as a browser (e.g., the Internet Explorer distributed by Microsoft) that executes on a client machine 32 and accesses the facility 10 via a network such as, for example, the Internet 34. Other examples of networks that a client may utilize to access the coupon generation and redemption facility 10 include a wide area network (WAN), a local area network (LAN), a wireless network (e.g., a cellular network), or the Plain Old Telephone Service (POTS) network.

### Database Structure

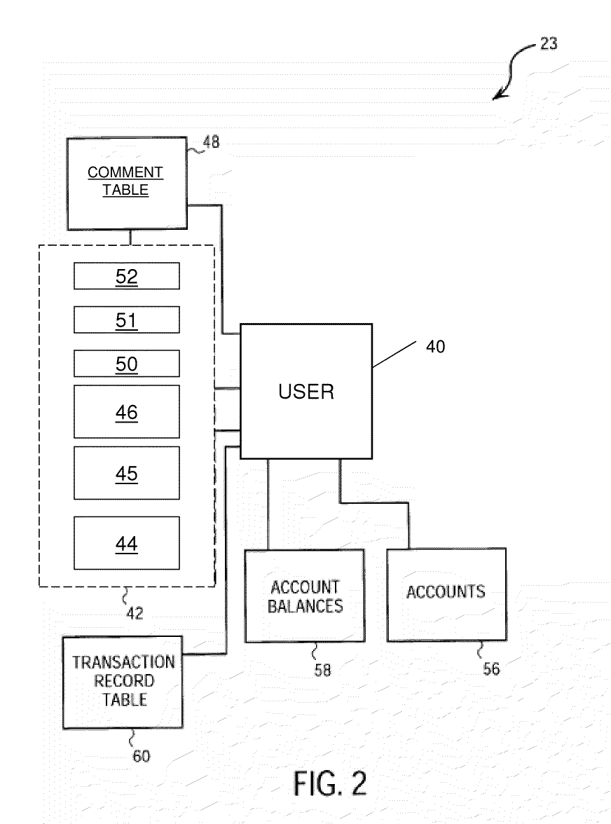

FIG. 2 is a database diagram illustrating an exemplary database 23, maintained by and accessed via the database engine server 22, which at least partially implements and supports the coupon generation and redemption facility 10. The database 23 may, in one embodiment, be implemented as a relational database, and includes a number of tables having entries, or records, that are linked by indices and keys. In an alternative embodiment, the database 23 may be implemented as collection of objects in an object-oriented database.

As shown, central to the database 23 is a user table 40, which contains a record for each user of the coupon generation and redemption facility 10. The database 23 also includes deal/coupon tables 42 that may be linked to the user table 40. Specifically, the tables 42 may include deal/coupon content table 44, archive table 45, commit table 46, redemption table 50, create power table 51 and commit power table 52. A user record in the user table 40 may be linked to multiple deals/coupons that are being, or have been, generated via the facility 10 and for which records exist within the coupon tables 42. The database 23 may also include a communication table 48 populatable with communication records that may be linked to one or more coupon records within the coupon tables 42 and/or to one or more user records within the user table 40. Each communication record within the table 48 may include, inter alia, a communication, description, history or other information pertaining to a coupon being generated via the coupon generation and redemption facility 10. A number of other tables may also be linked to the user table 40, such as an accounts table 56, an account balances table 58 and a transaction record table 60.

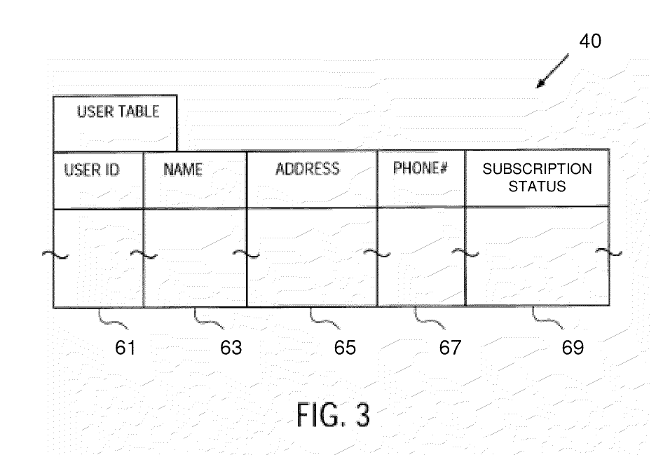

FIG. 3 is a diagrammatic representation of an exemplary embodiment of the user table 40 that is populated with records, or entries, for each user of the coupon generation and redemption facility 10. As shown, table 40 includes a user identifier column 61 that stores a unique identifier for each user. A name column 63 may store a first name, a middle initial and a last name for each user. An address column 65 may store full address information and/or other contact information for each user, e.g. a street name and number, city, zip code, state, email address, etc. A phone number column 67 stores a telephone number for each user. A subscription status column 69 may store, for each user, a value identifying the user's subscription status. That is, different values may be assigned to indicate whether a user has a confirmed or unconfirmed subscription, has an expired subscription (and which provides limited access to facility 10), and/or is accessing the facility on a pay-as-you-go basis such as via credit card, etc. It will be appreciated that any information other than that described above may populate the user table 40 without loss of generality.

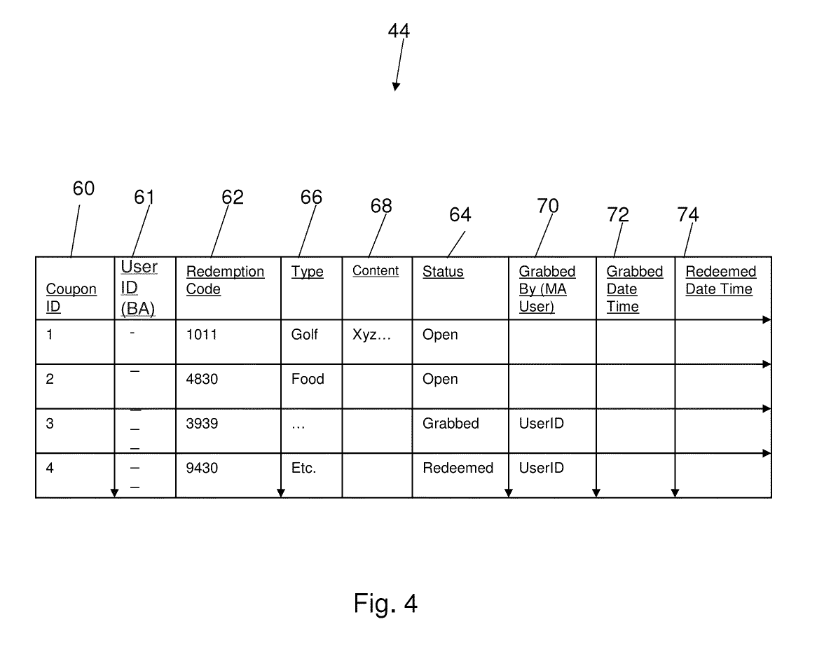

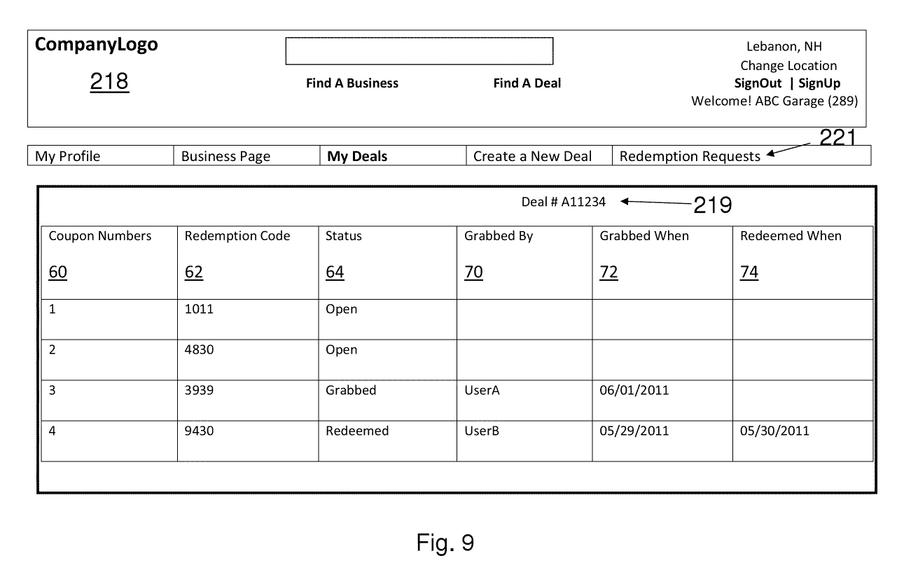

FIG. 4 is a diagrammatic representation of an exemplary embodiment of table 44, which is populated with deal/coupon records during use of the coupon generation and redemption facility 10. Referring now to FIG. 4, deal (coupon) table 44 is configured to store the content of the deals/coupons. This table includes a coupon ID column 60 to identify the coupons associated with a particular deal, a User ID column 61 to link each coupon with a particular (e.g., BA) user, and a Redemption Code column 62 to store one or more unique redemption codes associated with each coupon. A Type column 66 may be populated with one or more categories (e.g., dining, automotive, sports, etc.) within which the particular coupon may be associated, e.g., to facilitate searching and matching the coupon with potential MA users, as discussed hereinbelow. Content column 68 may be populated with the actual content (e.g., XML, jpeg, etc.,) or links to the content, of the particular coupon. Status column 64 may be populated with various status states, such as open (e.g., posted on the website), grabbed, or redeemed, as will be discussed in greater detail hereinbelow. A Grabbed By column 70 may be used to identify the MA user who committed to the particular coupon, while the Grabbed column 72 may be populated with the date (and/or time) the coupon was grabbed. Redemption column 74 may be populated with the date (and/or time) the coupon was actually redeemed. The additional tables 45, 46, 48, 50, 51 and 52 may be substantially similar to table 44, though configured to store their corresponding content. These additional tables may also include coupon ID and/or User ID columns 60 and 61, etc., to link their corresponding content to particular coupons and/or users. An additional column (not shown), may be used to store the Deal Number (DealID) 219 (FIG. 9) associated with each coupon.

Coupon Generation Process

As mentioned hereinabove, embodiments of the present invention provide an automated system and method for generating and facilitating the redemption of coupons. These embodiments enable various aspects of the process, including coupon generation, committing to redeem (i.e., coupon grabbing), and/or redeeming the coupon, in a web-based, client-server (including peer-to-peer) environment. The users may engage these embodiments on a subscription or pay-as-you-go basis. Moreover, the costs of such access may depend on the particular type of user account, with some users, such as the consumer (MA users), being potentially able to access the system for reduced, or even no charge. Particular embodiments may also be supported by advertisers, e.g., of products related to the currently posted deal(s). While the present invention is discussed within the environment of the exemplary coupon generation and redemption facility 10, it will readily be appreciated that the present invention may be used in any number of environments including network and on-line based transaction facilities in business-to-business, business-to-consumer and consumer-to-consumer applications.

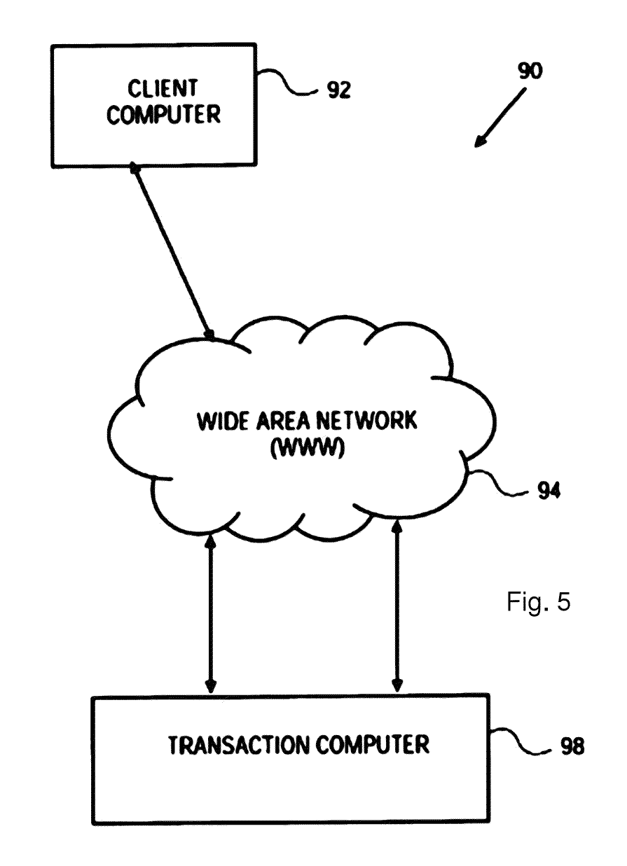

FIG. 5 is a simplified block diagram of a system 90 for generating and redeeming coupons in accordance with an exemplary embodiment of the present invention. In this embodiment, a client computer 92 is coupled to a transaction computer 98 via a communications network (e.g. a wide area network) 94. The client computer 92 represents a device that allows a user to interact with the coupon generation and redemption facility 10 or any other transaction facility 98. In one embodiment, the client computer 92 presents to a (e.g., BA) user a coupon generation/redemption interface for creating and redeeming deal/coupons via the transaction computer 98. Client computer 92 may also present, to (e.g., an MA) user, an interface for searching, committing to, and redeeming deal/coupons via the transaction computer 98.

The transaction computer 98, which supports a coupon generation and redemption facility such as shown at 10 of FIG. 1, handles transactions between various participants of the facility 10 including the user(s) of one or more client computers 92. In one embodiment, the transaction computer 98 may initially receive the personal information of the participant from the client computer 92, and generate a subscription result which determines whether, and to what extent, the user is granted access to the facility 10. The transaction computer then facilitates the generation of custom coupons, and the grabbing and redemption of the coupons, in accordance with various user interfaces presented by the computer 98, via the client computer 92, to the user.

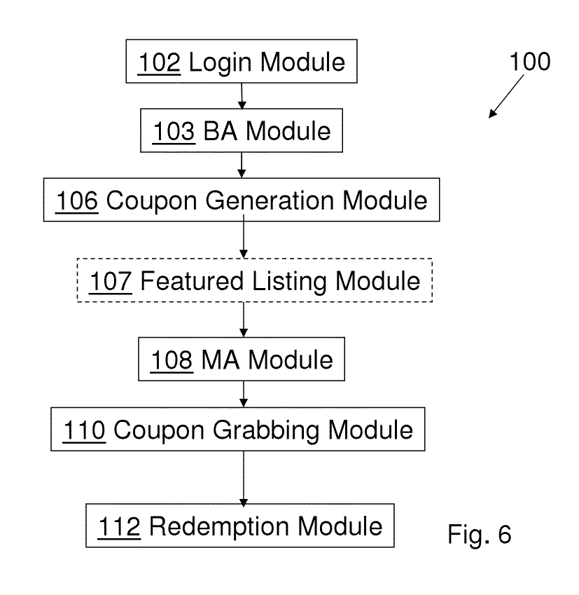

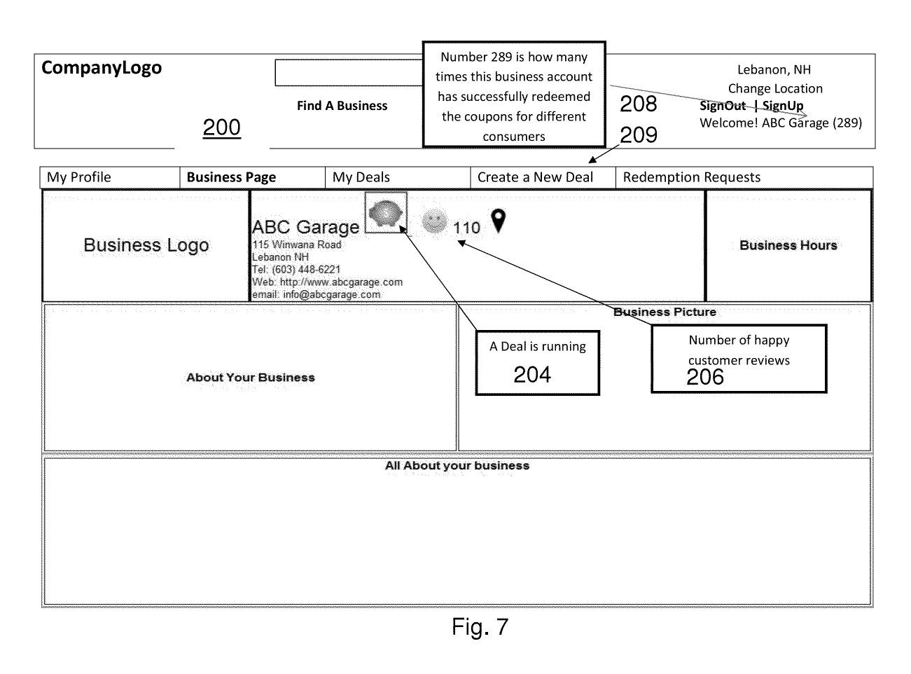

FIG. 6 shows a series 100 of interface modules, such as may take the form of a series of objects (or methods), that may be implemented by the coupon generation and redemption facility 10, e.g., in combination with the various tables of database 23, for the purposes of generating interfaces to effect the various functions of the embodiments hereof. The series 100 of interface modules shown in FIG. 6 will be described with reference to exemplary representations of the various interfaces as shown in FIGS. 7-12.

As shown, series 100 includes a login module 102, configured to generate a login interface through which a user of the facility 10 provides at least a user identifier and associated password. The user may also be requested to pay a fee for a subscription, etc.

A Business Account (BA) module 103 is configured to generate a BA interface, such as shown at 200 in FIG. 7. Module 103 interacts with the various tables of database 23 (FIG. 1) to enable interface 200 to display various deal/coupon parameters in an interactive format. In the embodiment shown, interface 200 is the default screen with which a Business Account user will be presented upon login to the website. In addition to helping publish/manage deals, interface 200 may present tools to enable the BA user to create their business page (e.g., a microwebsite) which may include a brief profile/summary of their business and their contact information, etc., as shown at 202. An icon 204 may indicate that a deal is currently running. Additional features, such as optional feedback display 206 and history display 208, may be used to indicate the number of favorable customer reviews, and the total number of transactions, respectively. The skilled artisan will recognize than any one or more of these icons/displays may be selectable to enable a user to drill down to more detailed, related information. For example, a user may click on optional feedback display 206 to read individual reviews posted by other users.

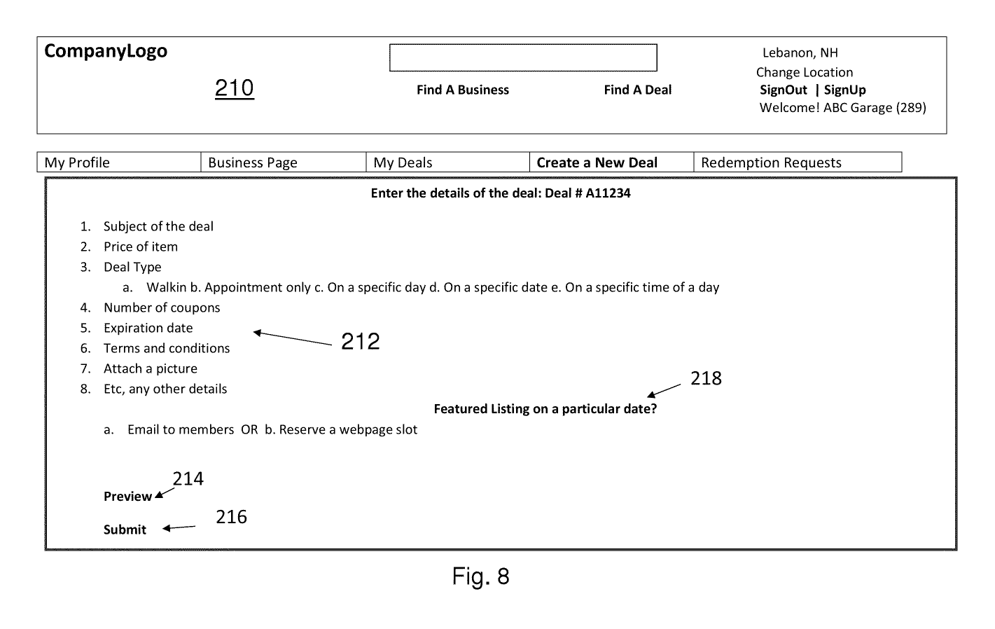

Returning to FIG. 6, coupon generation module 106 is configured to generate a coupon interface such as shown at 210 of FIG. 8. This exemplary interface 210, e.g., accessed by clicking on the “Create a New Deal” button 209 of interface 200 (FIG. 7), illustrates how the storage format of the various tables facilitates the creation of coupons (deals). In the embodiment shown, interface 210 may generate a list 212 of questions prompting the user to respond with parameters regarding their deal and how it should be published. Additional features, such as Preview, Submit, and Featured Listing buttons 214, 216 and 218, may also be provided.

Module 106 and interface 210 may be used to generate various types of deals tailored to any number of interests. Once created, the deals/coupons may be automatically broadcast (e.g., by email or other electronic messaging) to MA users, or others, based on matching their interests with the parameters of the deal. Module 106 may use communication (e.g., email) server(s) 21 (FIG. 1) to effect the broadcast. For example, a person who does not play Golf may not be interested in receiving notifications for a new Golf deal in his/her town. But other MA users who are golfers may sign up in advance to receive notification of a new deal for Golf in close proximity. (MA users may be provided with an option to receive such personalized emails regarding their preferences and tastes via an MA login interface as discussed hereinbelow. The system may also automatically select such users, e.g., based on previous grabbing/redeeming patterns.) In this Golf example, a BA user may choose a particular date(s) and time(s) (if available) in which the system may broadcast, e.g., by email, the deal to applicable MA users. In this manner, these embodiments serve as match-maker between BA and MA users.

In particular embodiments, module 106 is configured to provide this broadcast capability in the form of a Distribution Slot made available to BA users. Module 106 may be configured to provide MA users with a daily (e.g., email) digest of deals available depending upon the MA users' location. Module 106 may maintain a mailing (e.g., email) list for each location. BA users may select email distribution depending upon their business category. A Distribution Slot may be time and/or date specific, and may be available to only a limited number (e.g., one) BA user for each particular date and/or time.

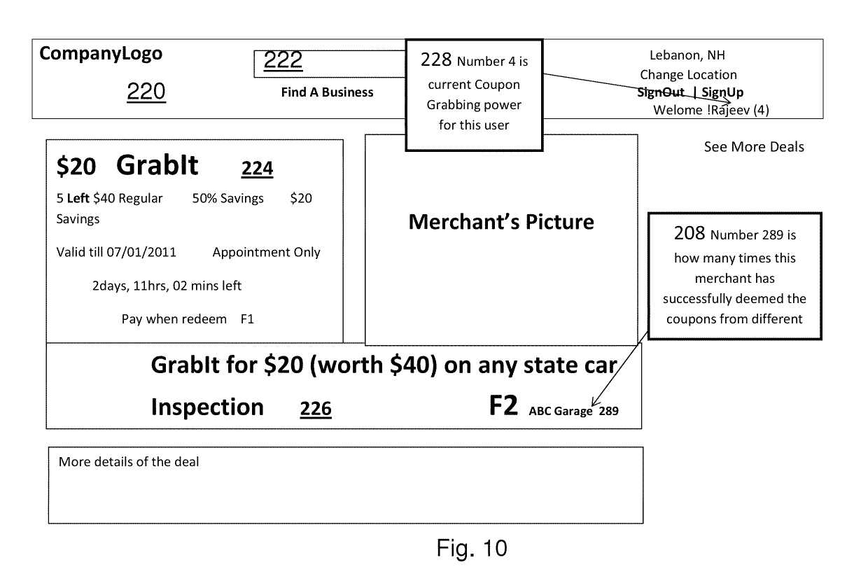

In addition, and/or as an alternative to the aforementioned automatic broadcast approach, an optional featured listing button 218 may be used to invoke an optional featured listing module 107 (shown in phantom in FIG. 6), which enables a BA user to designate particular deals as ‘featured’ for a particular date(s) and/or time(s), e.g., in a particular category. Featured deals may be highlighted or otherwise displayed in a prominent manner to MA/visitors as they browse the website of the present embodiments, as discussed below. In a manner similar to the Distribution Slot, module 106 may be configured to provide a featured listing slot selectable by a BA user, e.g., for a particular date and/or time slot, e.g., in a particular category, so that the listing is displayed on the front page (e.g., interface 220, FIG. 10) when a user is visiting the website.

Turning now to FIG. 9, module 106 may be configured to populate the various deal parameters entered by the BA user into the database, e.g., into table 44 (FIG. 4). The system may also automatically assign values, such as a Deal Number (e.g., DealID), shown at 219, to the particular deal, which may also be stored in the database and associated with table 44. Data from table 44 may also be displayed to the BA user via interface 218 as shown. Each deal may thus be assigned a deal number, and as mentioned hereinabove, a particular number of coupons. As shown, each coupon number may have its own properties, including status 64 (open, grabbed, redeemed, etc), the identity of the user who grabbed 72, and redeemed 74, etc., the coupon. These values will populate, substantially in real time, as events occur.

As also shown, each coupon may be automatically provided with a redemption code 62. This code may be known to the BA user creating the deal (and optionally to a redeeming MA user, as discussed herein, but not to other users, and may be created substantially as soon as the deal is created, i.e., as part of the deal creation process. When an MA user redeems a coupon, the BA may give this code to the MA, such as by printing it on a Point-of-Sale register receipt, or automatically via email generated by the system, so the MA may input this code on the website to mark this coupon as redeemed. In particular embodiments, if the business is new then the system may generate another redemption code provided to the MA user, and which may need to be entered into the system before the coupon will be marked as redeemed.

For example, a particular redemption code may be known to the MA user who grabbed the coupon, but not to others. Upon purchasing the goods/services, the MA user may give the code to the BA user who may then enter it into the system via the website to mark the coupon redeemed. As a further optional variation, particular embodiments may generate one or more additional unique redemption codes for each coupon, e.g., one given to the BA user, and another given to the MA user. This approach may provide additional security by requiring the parties to swap redemption codes and enter them into the system for redemption.

Still further alternatives may be provided, as discussed herein, once a BA user achieves “confirmed” status. For example, once the BA user receives confirmed status, then he/she may mark the coupon as redeemed without getting a code from MA user). Alternatively, the system may provide the confirmed BA user with a redemption code, which the BA user itself may enter upon delivery of the product or service to the MA user, such as by selecting the BA user's redemption button 221. It should be recognized that in any of the various redemption approaches discussed herein, once the redemption code (or codes) is entered, other fields associated with the particular coupon, such as status, redeemed when, etc., are automatically updated in the system.

Referring back to FIG. 6, when an MA user logs into the website, e.g., via login module 102, MA module 108 may present an MA interface 220 (FIG. 10). As shown in FIG. 10, interface 220 may be configured to display various deals, e.g., based on the particular MA user's location, profile and/or prior purchase patterns, etc. In the particular embodiment shown, interface 220 may include a relatively large display 224 of a particular deal, which may be based on the particular category (type) the MA may have entered in search field 222. Smaller displays of other deals may also be presented, such as shown at 226. Whether or not a particular deal is presented via large or small display 224, 226, respectively, may depend on whether or not the deal was an optional “featured” listing, as discussed hereinabove, and/or a “deal of the day” as determined automatically, e.g., substantially randomly or by a predetermined rotation, by the website. Additional information, such as the BA user's redemption history number 208, and the MA user's current coupon grabbing power 228 may also be displayed.

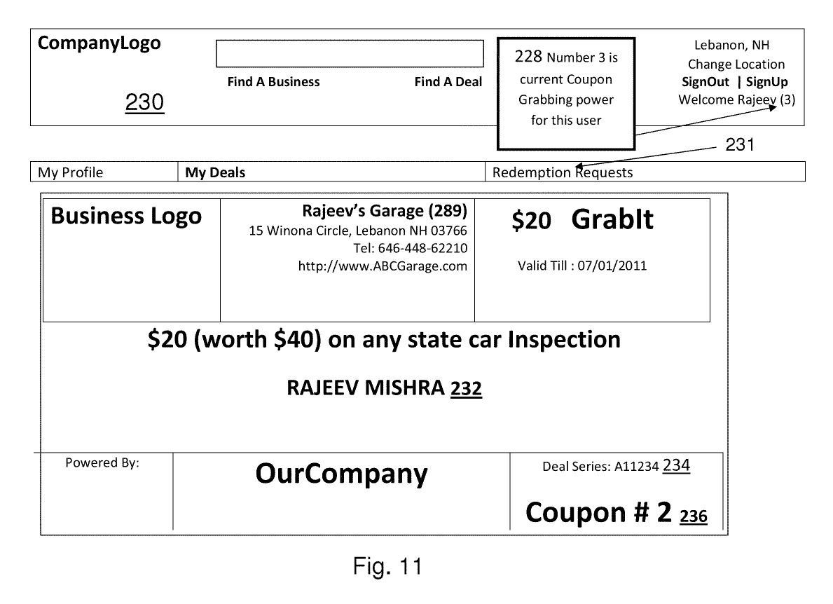

Referring back to FIG. 6, a coupon grabbing module 110 may be configured to enable the MA user to “grab” (e.g., commit to) a coupon by clicking on (e.g., as displayed via interface 220, FIG. 10), or by otherwise selecting it. As shown in FIG. 11, module 110 may then generate an interface 230 indicating the MA user, the deal number, and the coupon number of the grabbed coupon, shown at 232, 234 and 236, respectively.

In the particular example shown, interface 230 indicates that an MA user has grabbed coupon 2 from deal number A11234. Once the MA user grabs the coupon then his/her grabbing power is reduced, e.g., by 1, as shown by grabbing power icon 228.

It is noted that in this embodiment, in the event the BA user posting the deal was a “confirmed” user, then the coupon may be marked as “redeemed” by either the BA user via the website, or by the MA user inputting the redemption code via the website, e.g., using redemption button 231. In this latter instance, the code would be given to the MA user upon purchasing the goods/service associated with the coupon, as discussed hereinabove.

Alternatively, if unconfirmed, the BA user would be unable to obtain the redemption code via the website. Rather, if the BA user wanted to mark a coupon redeemed (instead of letting the MA user do so), the unconfirmed BA user would first need to obtain the redemption code from the MA user. To facilitate this, redemption module 112 (FIG. 6) may be configured to display the redemption code on interface 230.

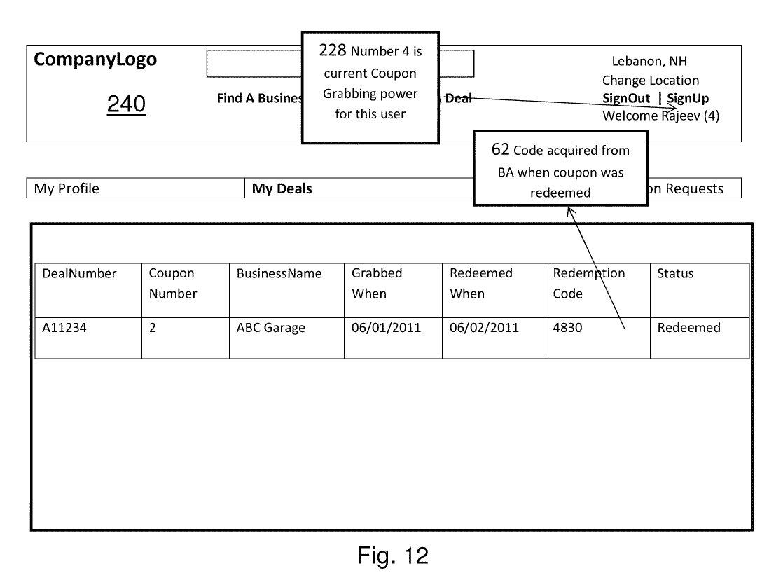

Turning now to FIG. 12, redemption module 112 (FIG. 6) may generate an interface 240, indicating that the redemption code has been entered, and the coupon marked as redeemed. As mentioned above, the redemption code may have been entered by the MA user, e.g., by selecting the MA user's redemption button 231 (FIG. 11). Alternatively, the BA user, if confirmed, may have automatically redeemed the coupon (e.g., with or without the need to enter the redemption code), simply by selecting the coupon, e.g., using the BA user's redemption button 221 (FIG. 9) as discussed hereinabove. Once the coupon is redeemed, the MA user's grabbing power increases, e.g., by 1, as shown by grabbing power icon 228.

It should be noted that in the event the MA user fails to redeem the coupon which he/she grabbed, then this user's grabbing power may automatically increment by 1 after a predetermined period of time (e.g., 3 months). This has the effect of removing the penalty associated with not redeeming, after a period of time.

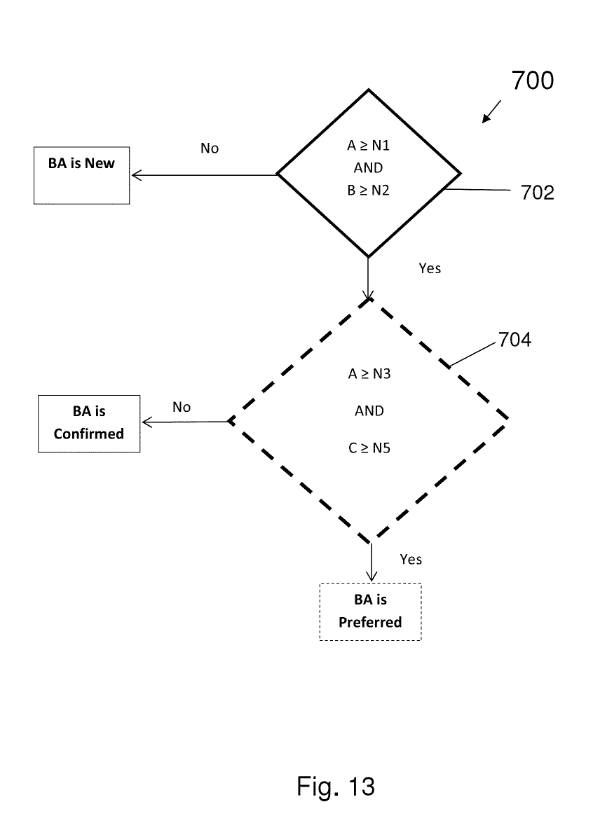

Methods for coupon generation and redemption in accordance with embodiments of the present invention, implemented in a client-server environment, using a network-based transaction facility, such as the coupon generation and redemption facility 10, will now be described as illustrated by the flow charts of FIGS. 13-17D. As shown in FIG. 13, method 700 includes using BA module 103 (FIG. 6) and database tables 42 (FIG. 2) to track BA users and automatically upgrade the BA users' account from unconfirmed to confirmed, and optionally, to higher level accounts such as preferred. In the embodiment shown, “A” refers to a BA user's “redeem history” count from unique MA users. “B” refers to the number of MA users (i.e., “redeemed users”) who have redeemed coupons from both this BA user and at least one other BA user. “C” refers to the number of “Senior Redeemed Users” who have redeemed coupons from this BA User and at least two other BA users. “D” refers to the “Redeem History” count for this BA User. N1, N2, N3, N4 & N5 are predetermined integers. As shown, at 702, the system determines whether a BA user's redeem history and redeemed user counts are at or above predetermined levels. If no, the BA User's account is classified as “New” or “Unconfirmed”. If yes, then the BA User's account becomes Confirmed. Optionally, as shown in phantom at 704, the system determines whether the BA User's redeem history and Senior Redeemed User counts are at or above predetermined levels. If yes, then the BA User's account becomes Preferred.

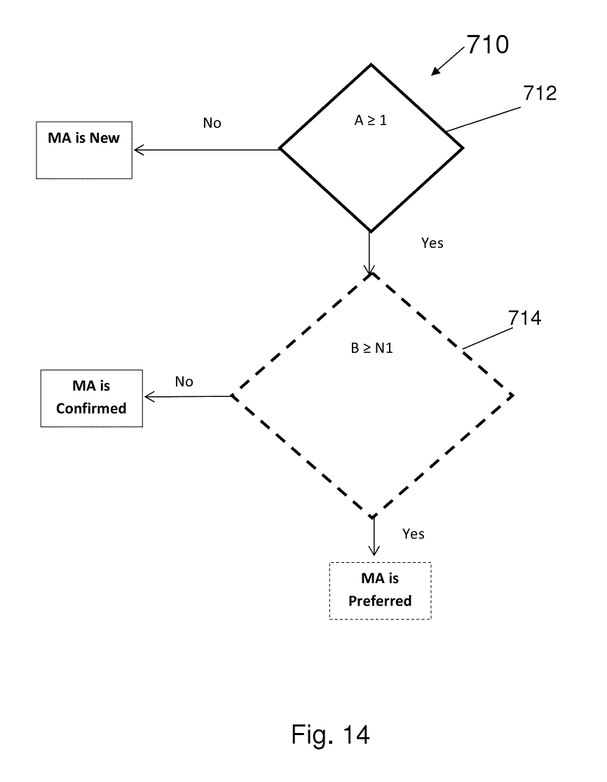

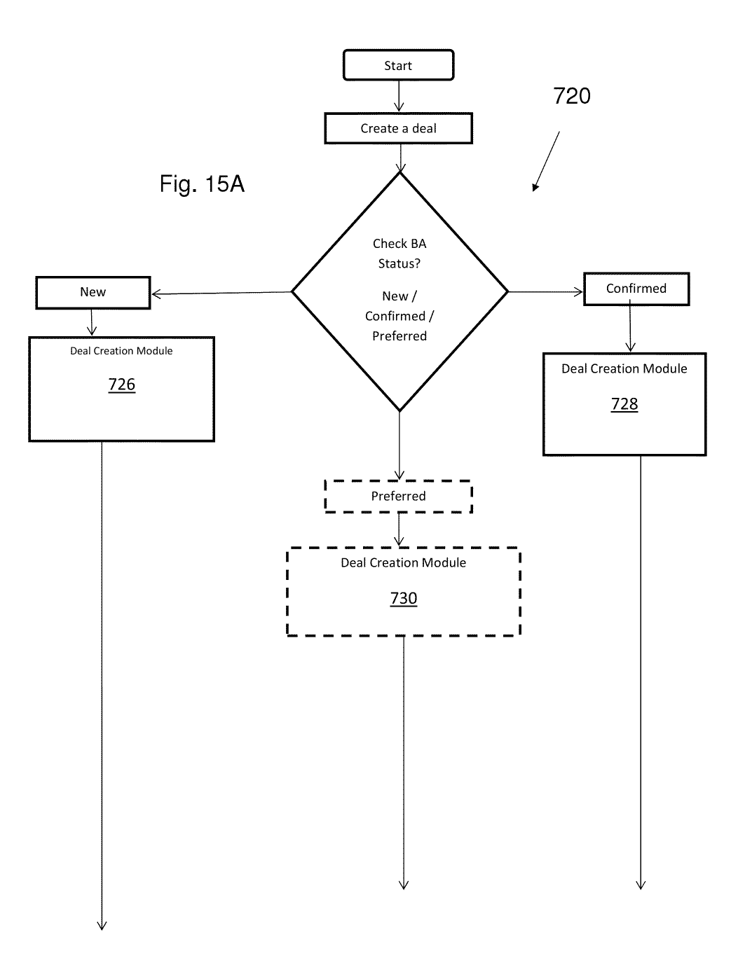

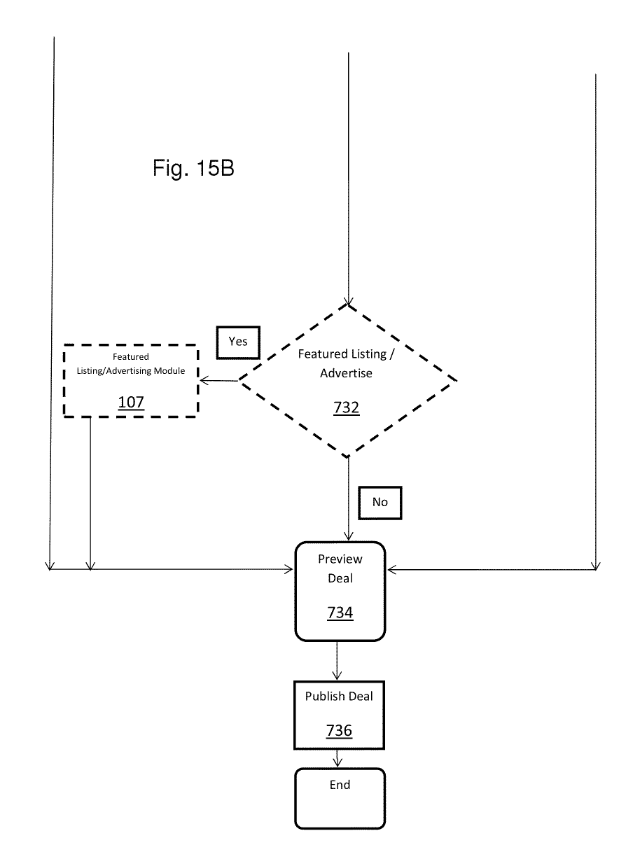

Similarly, as shown in FIG. 14, method 710 includes using MA module 108 (FIG. 6) and database tables 42 (FIG. 2) to track MA users and automatically upgrade the MA users' accounts from unconfirmed to confirmed, and optionally, to higher level accounts such as preferred. In the embodiment shown, “A” refers to the redeem history count for a particular MA user, and “B” refers to the redeem history count for any BA Account with which this particular MA user has redeemed a coupon. N1 is a predetermined integer. As shown, at 712, the system determines whether an MA user's redeem history count is at or above a predetermined level (e.g., 1, in the example shown). If no, then the MA User's account is classified as “New” or “Unconfirmed”. If yes, then the MA User's account becomes Confirmed. Optionally, as shown in phantom at 714, the system determines whether the redeem history counts for at least some of the BA Users with which the MA User has done business, are at or above predetermined levels. If yes, then the BA User's account becomes Preferred.

Turning now to FIGS. 15A-15B, method 720 includes using the login, BA, and Coupon (e.g., Deal) Generation modules 102, 103, 106 (FIG. 6) to enable a BA user to login at 722. Upon login, the system may check the status of the BA user at 724. Once the BA user's account status is determined, the deal generation module 106 presents interfaces 210 and 218 (FIGS. 8, 9) as discussed hereinabove, to enable the BA user to create deals/coupons as permitted based on the account type/status. In a particular example, at 726, a new user is permitted to create a deal with only a limited number of coupons, and with limited features, e.g., without a picture. Each deal may have multiple coupons. The system may generate one (and optionally, additional) redemption code(s) for each coupon. For example, the system may generate a single redemption code may be known by only one of the parties, which party will then share it with the other in order to mark the coupon redeemed, as discussed hereinabove. Alternatively, to provide potentially more robust security, the system may generate two (or more) mutually distinct redemption codes for each coupon, e.g., one for use by a grabbing MA user, and the other for use by the BA user, and/or other authorized parties such as the website administrator. The BA redemption code may be printed (e.g., rendered) on the particular coupon grabbed by the MA user. In the event two (or more) redemption codes are generated, both the BA and MA may be required to enter one another's code on website for the coupon to be marked as redeemed.

At 728, a confirmed user is permitted to create a deal with fewer limitations that those associated with new users. For example, the confirmed BA user may create a greater number of coupons and publish with a greater number of features than the unconfirmed user. Some features, such as the ability to designate a deal as a “Featured” may not be available. The system may also use any of the redemption approaches discussed above at step 726. In particular embodiments, confirmed BA users may enjoy a slightly simplified approach in which, for example, the system generates only a single redemption code that will be known only to the BA user until the goods/services have been rendered, at which point the BA user may give the redemption code to the MA user for the MA user to enter via the website.

Optionally, as shown in phantom, in embodiments employing a third type of BA user, e.g., the optional Preferred BA user/account, module 106 permits the preferred user to create 730 a deal in which substantially all of the various deal creation features are available. Examples of such features include, but are not limited to the ability to provide both Pictures and Text, to select specific days, times, and to create automatically recurring deals, etc. As described above with respect to 726 and 728, each deal may have multiple coupons. Similarly any of the foregoing redemption code approaches may be used, though it is anticipated that the simplified, more lenient approaches, such as the use of a single redemption code, may be used, since the preferred user may be generally more trusted than other user types. Moreover, the preferred BA user may be given the authority to enter the redemption code itself, e.g., to simplify the process for purchasers.

At optional step 732, also shown in phantom, users such as preferred users in the embodiment shown, may have the option of designating their deal as a “Featured” listing, e.g., using featured listing module 107. The deal may be previewed at 734, and published at 736.

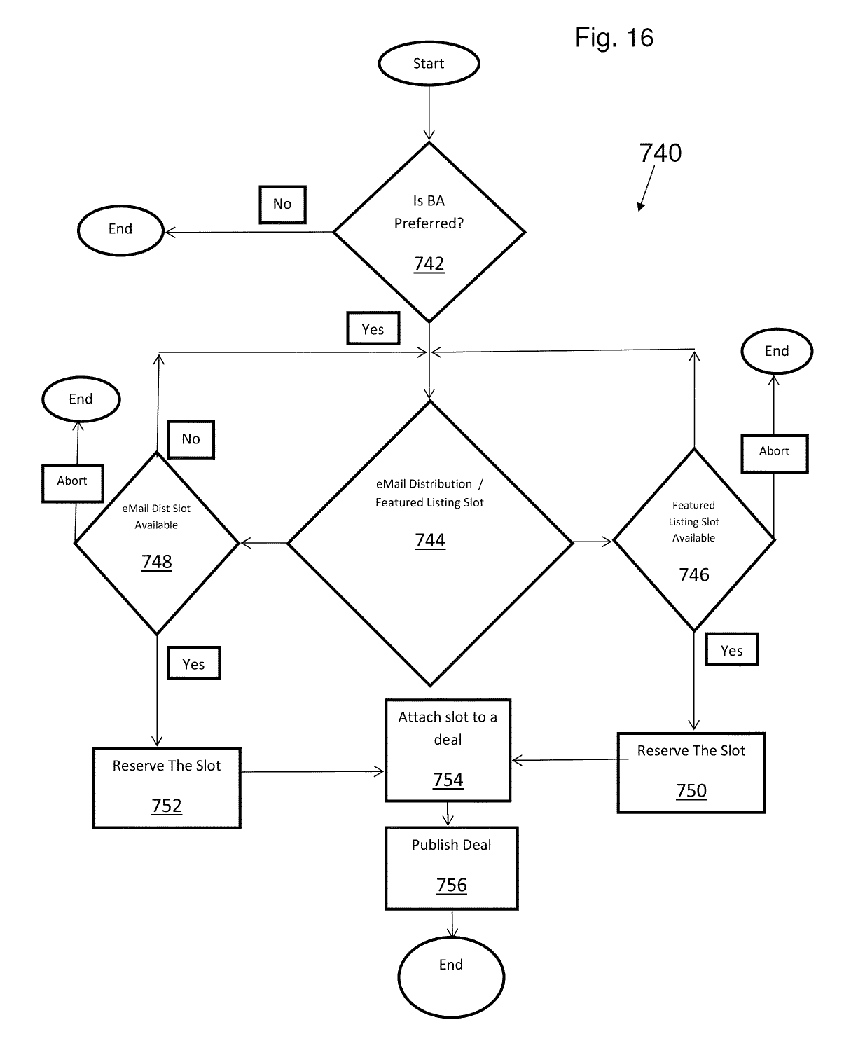

Turning now to FIG. 16, a representative embodiment of the operation of the optional featured listing module 107 is shown and described at optional method 740. Module 107 may determine 742 whether the user is qualified to post featured (and/or broadcastable) listings. In the embodiment shown, users must be preferred in order to qualify, but the qualifications may be different in other embodiments. If qualified, the user is enabled 744 to select specific Featured Listing and/or Broadcast Distribution slots, e.g., based on desired dates and/or times. The system then determines whether the requested slots are available at 746 and 748, and if so, reserves the slots at 750, 752. The slots may then be attached 754 to the deal, and the deal published 756.

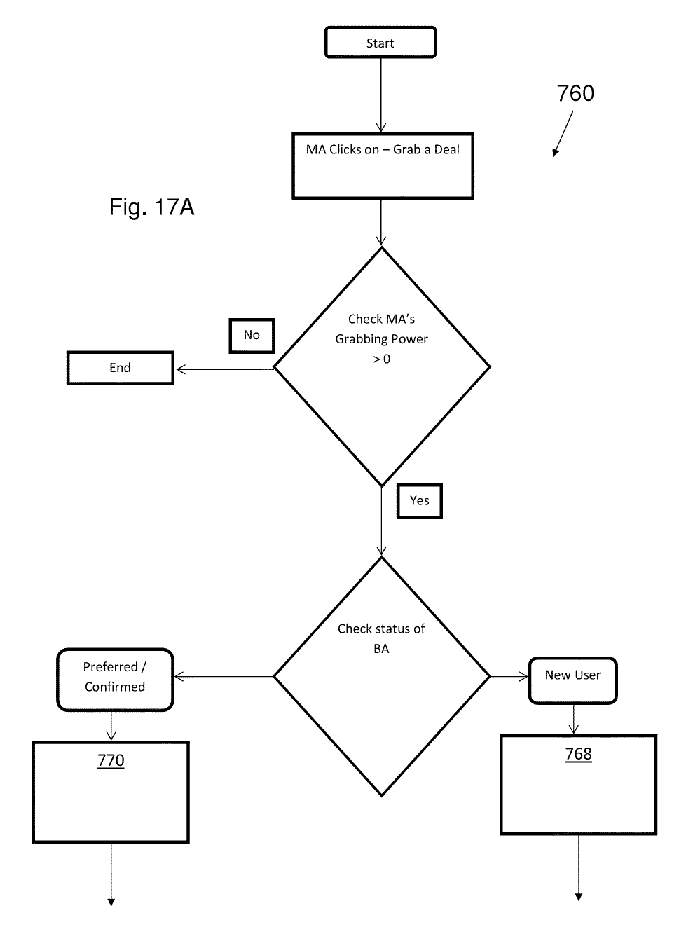

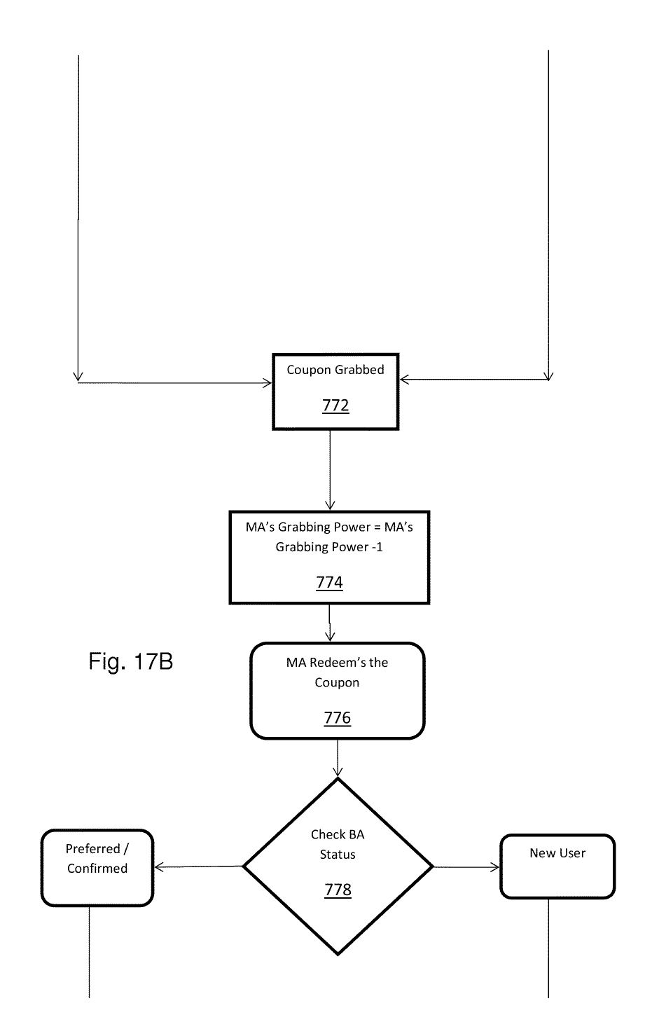

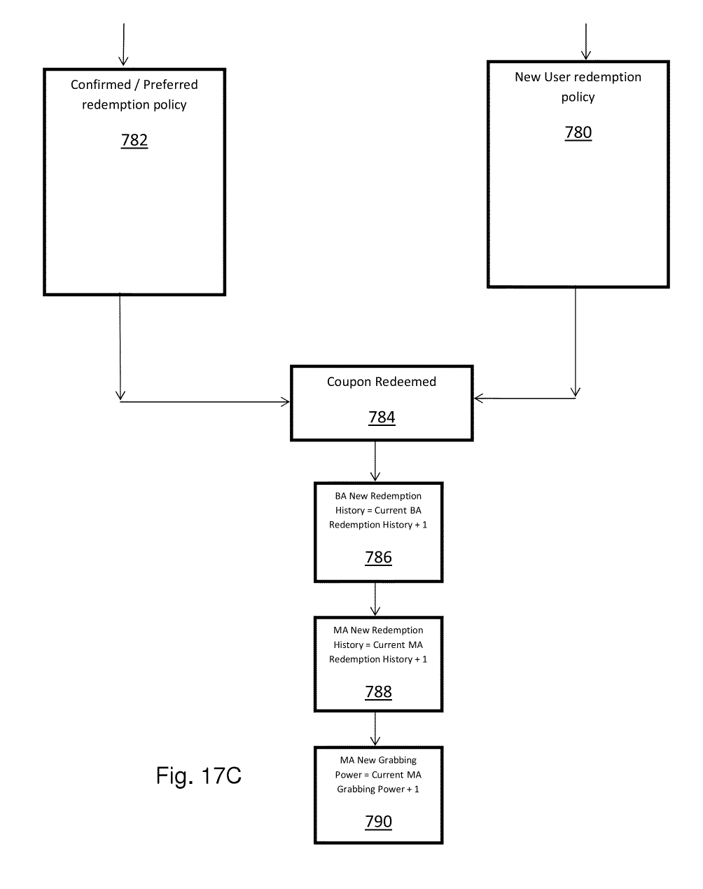

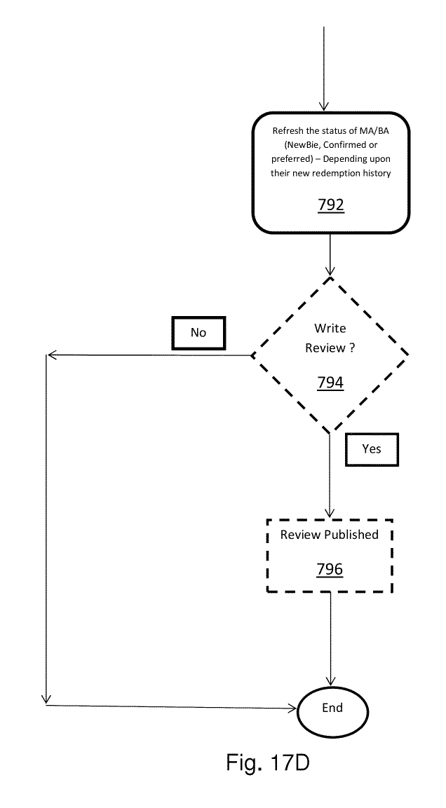

Turning to FIGS. 17A-17D, a representative method 760 of grabbing and redeeming a coupon is shown and described. This method begins by an MA user clicking 762 on a deal, e.g., using coupon grabbing module 110 as discussed hereinabove. Module 110 then checks 764 the MA user's grabbing power, and if sufficient, checks the status 766 of the listing BA user. If the BA user is new, then the coupon is printed 768, e.g., with the details of the name, including the names of the parties and at least one redemption code thereon, as may be given to the new BA user to mark the coupon redeemed, as discussed hereinabove. It should be recognized that as used herein, a coupon may be “printed” either physically, e.g., on paper, or virtually, e.g., by rendering as a pdf, image, or substantially any other rendering format. The BA User may also be notified, e.g., electronically using communication server 21 (FIG. 1) that the coupon has been grabbed.

Alternatively, if the BA user is not new, e.g., is a confirmed or preferred user, then the coupon is printed 770 substantially as at 768, but optionally without the need to include the redemption code as discussed hereinabove. In this regard, it should be noted that any of the various redemption approaches discussed herein, may be used any of the various embodiments, without departing from the scope of the present invention.

Module 110 marks 772 the coupon as grabbed in database 23 (FIG. 1), and reduces 774 the MA user's grabbing power, e.g., by 1 as shown.

The MA user may then seek to redeem 776 the coupon, at which point the redemption module 112 may be operated as shown and described hereinabove. Module 112 may check the BA user's status at 778. If the BA user is new, then the new user redemption approach may be used at 780. For example, the users may exchange their redemption codes with one another, such as described hereinabove regarding the two-redemption code approach. Once each party enters the other party's redemption code into the system, module 112 may mark 784 the coupon as having been redeemed. Alternatively, if the BA user is not new, e.g., is confirmed or preferred, then one of the simpler redemption approaches may be used at 782. For example, the BA user may simply give the coupon redemption code to the BA user, who then enters the code to enable the system to record 784 the coupon as redeemed.

At 786, module 112 updates the BA user's redemption history, updates 788 the MA user's redemption history, and updates 790 the MA user's grabbing power, e.g., by adding 1 to each. The status of the BA and MA user is also refreshed 792, in accordance with their new redemption histories. Optionally, as shown in phantom, the system may provide the BA and MA users with the opportunity to write a review at 794 and to have it published 796 on the website.

In summary, it will be appreciated that the above described embodiments, including the interfaces and underlying technologies, provide a convenient vehicle for deal/coupon creation and redemption, in a real-time, multi-user collaborative environment using a seamlessly integrated transaction facility. Moreover, these embodiments provide an incentive for consumers to only capture coupons the consumer intends to redeem, and to then follow through with redeeming the grabbed coupons. This, in turn, is expected to provide a relatively high ratio of redemptions to coupons generated, to provide the business account users, i.e., the providers of the advertised goods/services, with a relatively high level of predictability and confidence as to the outcome of their deal/coupon promotion(s).

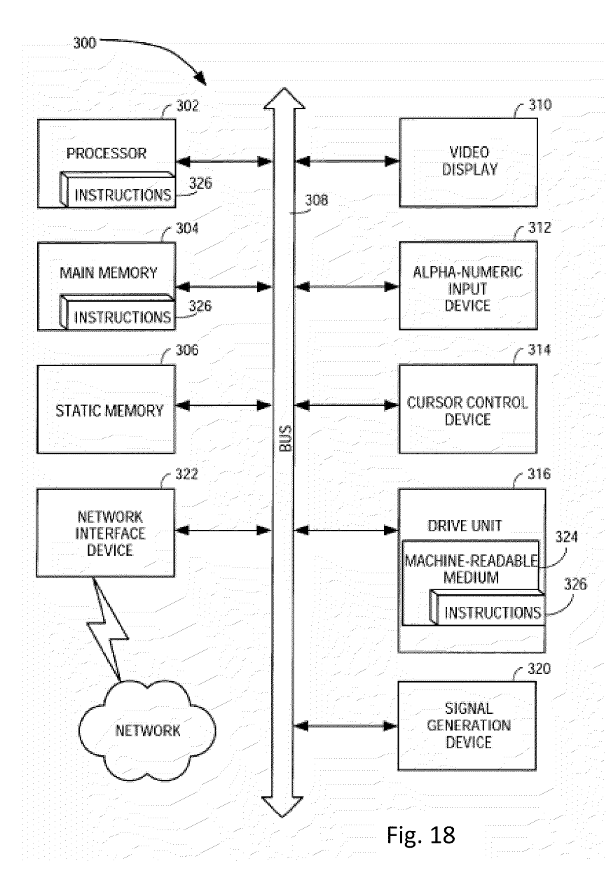

FIG. 18 shows a diagrammatic representation of a machine in the exemplary form of a computer system 300 within which a set of instructions, for causing the machine to perform any one of the methodologies discussed above, may be executed. In alternative embodiments, the machine may include a network router, a network switch, a network bridge, Personal Digital Assistant (PDA), a cellular telephone, a web appliance or any machine capable of executing a sequence of instructions that specify actions to be taken by that machine.

The computer system 300 includes a processor 302, a main memory 304 and a static memory 306, which communicate with each other via a bus 308. The computer system 300 may further include a video display unit 310 (e.g., a liquid crystal display (LCD), plasma, cathode ray tube (CRT), etc.). The computer system 300 may also include an alpha-numeric input device 312 (e.g., a keyboard, touchscreen, or voice actuation), a cursor control device 314 (e.g., a mouse), a drive (e.g., disk, flash memory, etc.,) unit 316, a signal generation device 320 (e.g., a speaker) and a network interface device 322.

The drive unit 316 includes a computer-readable medium 324 on which is stored a set of instructions (i.e., software) 326 embodying any one, or all, of the methodologies described above. The software 326 is also shown to reside, completely or at least partially, within the main memory 304 and/or within the processor 302. The software 326 may further be transmitted or received via the network interface device 322. For the purposes of this specification, the term “computer-readable medium” shall be taken to include any medium that is capable of storing or encoding a sequence of instructions for execution by the computer and that cause the computer to perform any one of the methodologies of the present invention. Thus, a method and apparatus for generating custom coupons in a network-based transaction facility have been described.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

Furthermore, embodiments of the present invention include a computer program code-based product, which includes a computer readable storage medium having program code stored therein which can be used to instruct a computer to perform any of the functions, methods and/or modules associated with the present invention. The computer storage medium includes any of, but not limited to, the following: CD-ROM, DVD, magnetic tape or disks, phase change memory, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, and/or any other appropriate static or dynamic memory or data storage devices.

It should be noted that the various modules and other components of the embodiments discussed hereinabove may be configured as hardware, as computer readable code stored in any suitable computer usable or storage medium as mentioned above, and/or as combinations thereof, without departing from the scope of the present invention.

It should be further understood that any of the features described with respect to one of the embodiments described herein may be similarly applied to any of the other embodiments described herein without departing from the scope of the present invention.

In the preceding specification, the invention has been described with reference to specific exemplary embodiments for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

The above systems are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic or non-volatile, and may be retrieved by the user in any of: conventional computer storage, display (e.g., CRT, flat panel LCD, plasma, etc.) and/or hardcopy (i.e., printed) formats. The programming of the present invention may be implemented by one skilled in the art of computer systems and/or software design.

Having thus described the invention, what is claimed is:

1. A computer implemented system in a client-server environment, for coupon creation, publication, and redemption, the system comprising:
a server including:
a business account module configured to assign a deal creation power to a product or service provider accessing a website with a client;
a coupon generation module configured to generate, on behalf of the provider, a listing of a deal and a predetermined number of coupons associated with a deal;
the coupon generation module configured to publish the coupons via the website;
a database configured for recording and updating the provider's history of coupon generation;
a member account module configured to assign a coupon grabbing power and a coupon redemption power to a product or service consumer;
a coupon grabbing module configured to enable the consumer to grab at least one of the coupons via a client accessing the website;
the database configured for recording and updating the consumer's history of coupon grabbing;
a redemption module configured to enable the grabbed coupon to be redeemed;
the database configured for recording and updating the consumer's history of coupon redemption;
the database configured for recording and updating the provider's history of coupon redemption;
the redemption module configured for transforming the consumer's grabbing power in accordance with at least one of the consumer's history of coupon grabbing and history of coupon redemption; and
the redemption module configured for transforming the provider's deal creation power in accordance with at least one of the provider's history of coupon generation and history of coupon redemption.

2. The system of claim 1, wherein the coupon generation module is configured to enable the provider to self-provision, via a client accessing the website, the listing of the deal and generation of the predetermined number of coupons associated with the deal.

3. The system of claim 1, wherein the coupon grabbing module is configured to assign at least one redemption code to each coupon.

4. The system of claim 3, wherein the redemption module is configured to enforce a redemption protocol which includes entry of the redemption code in order to redeem the coupon.

5. The system of claim 4, wherein the redemption module is configured to vary the redemption protocol based on at least one of the consumer's grabbing power and the provider's deal creation power.

6. The system of claim 4, wherein the redemption module is configured to enforce a redemption protocol which includes automatically revealing the redemption code to one of the provider and consumer, and requiring entry of the redemption code into the website by the other of the provider and consumer.

7. The system of claim 6, wherein the redemption module is configured to enforce a redemption protocol which includes requiring mutually distinct redemption codes assigned to each of the provider and consumer to be entered into the website by the other of the provider and consumer.

8. The system of claim 1, wherein the redemption module is configured to transform the account type assigned to a particular consumer.

9. The system of claim 1, wherein the redemption module is configured to transform the account type assigned to a particular provider.

10. The system of claim 1, wherein the redemption module is configured to transform the consumer's grabbing power by reducing the grabbing power once a coupon is grabbed.

11. The system of claim 10, wherein the redemption module is configured to transform the consumer's grabbing power by increasing the grabbing power once the grabbed coupon is redeemed.

12. The system of claim 1, wherein the redemption module is configured to transform the provider's deal creation power by selectively adjusting the deal creation power based on the provider's history of deal creation and redemption.

13. The system of claim 12, wherein the redemption module is configured to transform the provider's deal creation power by selectively adjusting the deal creation power based on a combination of the provider's history of deal creation and redemption and the histories of coupon grabbing and redemption of consumers who have grabbed and redeemed the provider's coupons.

14. The system of claim 1, wherein the redemption module is configured to enhance the provider's deal creation power by enabling the provider to designate a deal as Featured.

15. The system of claim 1, wherein said redemption module is configured to enhance the provider's deal creation power by enabling the provider to designate a deal for being broadcast.

16. The system of claim 8, further comprising a permissions module configured to provide selective access to the server by one or more users at one or more client computers.

17. A computer implemented method in a client-server environment, for coupon creation, publication, and redemption, the method comprising:
at the server:
(a) assigning, with a business account module, a deal creation power to a product or service provider accessing a website with a client;
(b) generating on behalf of the provider, with a coupon generation module, a listing of a deal and a predetermined number of coupons associated with a deal;
(c) publishing, with the coupon generation module, the coupons via the website;
(d) tracking and updating a database with the provider's history of coupon generation;
(e) assigning, with a member account module, a coupon grabbing power and a coupon redemption power to a product or service consumer;
(f) enabling, with a coupon grabbing module, the consumer to grab at least one of the coupons via a client accessing the website;
(g) tracking and updating the database with the consumer's history of coupon grabbing;
(h) redeeming, with a redemption module, the grabbed coupon;
(i) tracking and updating the database with the consumer's history of coupon redemption;
(j) tracking and updating the database with the provider's history of coupon redemption;
(k) transforming the consumer's grabbing power in accordance with at least one of the consumer's history of coupon grabbing and history of coupon redemption; and
(l) transforming the provider's deal creation power in accordance with at least one of the provider's history of coupon generation and history of coupon redemption.

18. The method of claim 17, wherein said generating (b) comprises enabling the provider to self-provision, via a client accessing the website, the listing of the deal and generation of the predetermined number of coupons associated with the deal.

19. The method of claim 17, comprising assigning at least one redemption code to each coupon.

20. The method of claim 19, comprising enforcing, with the redemption module, a redemption protocol which includes entry of the redemption code in order to redeem the coupon.

21. The method of claim 20, comprising varying the redemption protocol based on at least one of the consumer's grabbing power and the provider's deal creation power.

22. The method of claim 20, comprising enforcing a redemption protocol which includes automatically revealing the redemption code to one of the provider and consumer, and requiring entry of the redemption code into the website by the other of the provider and consumer.

23. The method of claim 22, comprising enforcing a redemption protocol which includes requiring mutually distinct redemption codes assigned to each of the provider and consumer to be entered into the website by the other of the provider and consumer.

24. The method of claim 17, wherein said transforming (k) comprises transforming the account type assigned to a particular consumer.

25. The method of claim 17, wherein said transforming (l) comprises transforming the account type assigned to a particular provider.

26. The method of claim 17, wherein said transforming (k) further comprises reducing the consumer's grabbing power once a coupon is grabbed.

27. The method of claim 26, where said transforming (k) further comprises increasing the consumer's grabbing power once the grabbed coupon is redeemed.

28. The method of claim 17, wherein said transforming (l) further comprises selectively adjusting the provider's deal creation power based on the provider's history of deal creation and redemption.

29. The method of claim 28, wherein said transforming (l) further comprises selectively adjusting the provider's deal creation power based on a combination of the provider's history of deal creation and redemption and the histories of coupon grabbing and redemption of consumers who have grabbed and redeemed the provider's coupons.

30. The method of claim 17, wherein said transforming (l) further comprises enhancing the provider's deal creation power by enabling the provider to designate a deal as Featured.

31. The method of claim 17, wherein said transforming (l) further comprises enhancing the provider's deal creation power by enabling the provider to designate a deal for being broadcast.

32. The method of claim 17, further comprising providing, with a permissions module, selective access to the server by one or more users at one or more client computers.

33. An article of manufacture for coupon creation, publication, and redemption, in a client-server environment, said article of manufacture comprising:
a computer usable medium having a computer readable program code embodied therein, said computer usable medium having computer readable program code for:
(a) assigning, with a business account module, a deal creation power to a product or service provider accessing a website with a client;
(b) generating on behalf of the provider, with a coupon generation module, a listing of a deal and a predetermined number of coupons associated with a deal;
(c) publishing, with the coupon generation module, the coupons via the website;
(d) tracking and updating a database with the provider's history of coupon generation;
(e) assigning, with a member account module, a coupon grabbing power and a coupon redemption power to a product or service consumer;
(f) enabling, with a coupon grabbing module, the consumer to grab at least one of the coupons via a client accessing the website;
(g) tracking and updating the database with the consumer's history of coupon grabbing;
(h) redeeming, with a redemption module, the grabbed coupon;
(i) tracking and updating the database with the consumer's history of coupon redemption;
(j) tracking and updating the database with the provider's history of coupon redemption;
(k) transforming the consumer's grabbing power in accordance with at least one of the consumer's history of coupon grabbing and history of coupon redemption; and
(l) transforming the provider's deal creation power in accordance with at least one of the provider's history of coupon generation and history of coupon redemption.
